(19) United States
(12) Patent Application Publication
(10) Pub. No.: US 2025/0320949 A1
(43) Pub. Date: Oct. 16, 2025

(54) PIPE PROTECTION SLEEVE

(71) Applicant: Oceaneering International, Inc., Houston, TX (US)

(72) Inventors: Pedro Gall FERNANDES, MACAÉ (BR); Ulisses CARVALHO DO ESPÍRITO SANTO, MACAÉ-RJ (BR); Daniel Mattos GONÇALVES DA COSTA, MACAÉ (BR)

(73) Assignee: Oceaneering International, Inc., Houston, TX (US)

(21) Appl. No.: 19/173,003

(22) Filed: Apr. 8, 2025

Related U.S. Application Data
(60) Provisional application No. 63/632,245, filed on Apr. 10, 2024.

(51) Int. Cl. F16L 57/02

(52) U.S. Cl. CPC F16L 57/02

(57) ABSTRACT

ROV operable protection sleeve 1 comprises a clamp fully operated by a remotely operated vehicle (ROV) without the need for any auxiliary equipment for its operation/installation, where all actuation and operation of ROV operable protection sleeve 1 is mechanical without the need to use the ROV's hydraulics. It comprises a remotely operated vehicle (ROV) interface panel, a mechanical clamp actuator, and a bipartite clamp comprising a fixed clamp hingedly connected to a movable clamp.

### CROSS-REFERENCE TO RELATED APPLICATIONS

This application claims priority through U.S. Provisional Application 63/632,245 filed on Apr. 10, 2024.

### BACKGROUND OF THE INVENTION

Subsea flexible lines may encounter external damage due to interference between one or more adjacent subsea lines. A protection sleeve that embraces a riser may be used to protect the riser and/or the damaged area of the riser against clashing of adjacent risers/umbilicals. Prior art teaches a bipartite clamp manually assembled before launching the subsea line.

### BRIEF DESCRIPTION OF DRAWINGS

Various figures are included herein which illustrate aspects of embodiments of the disclosed inventions.

FIG. 1 is a view in partial cutaway perspective of an exemplary remotely operated vehicle (ROV) operable pipe protection sleeve in a closed configuration;

FIG. 2 is a view in partial perspective of an exemplary ROV operable pipe protection sleeve in a partially opened configuration;

FIG. 3 is a view in partial perspective of an exemplary ROV operable pipe protection sleeve in a closed configuration;

FIG. 4 is a view of an exemplary spindle, flange, and pushing plate;

FIG. 5 is a view of an exemplary spindle, arm, and pushing plate;

FIG. 6 is a view of an exemplary spindle, arm, and pushing plate;

FIG. 7 is a view in partial perspective of an exemplary ROV interface panel;

FIG. 8 is a view in partial perspective of an exemplary ROV interface panel and cage;

FIG. 9 is a view in partial perspective of an exemplary ROV operable pipe protection sleeve in a closed configuration;

FIG. 10 is a schematic view from a top down and side perspective of an exemplary ROV operable pipe protection sleeve;

FIG. 11 is a top down view of an exemplary ROV operable pipe protection sleeve in a partially closed position; and

FIG. 12 is a view in partial perspective illustrating ROV operation of an exemplary ROV operable pipe protection sleeve.

### DETAILED DESCRIPTION OF EMBODIMENTS OF THE INVENTION

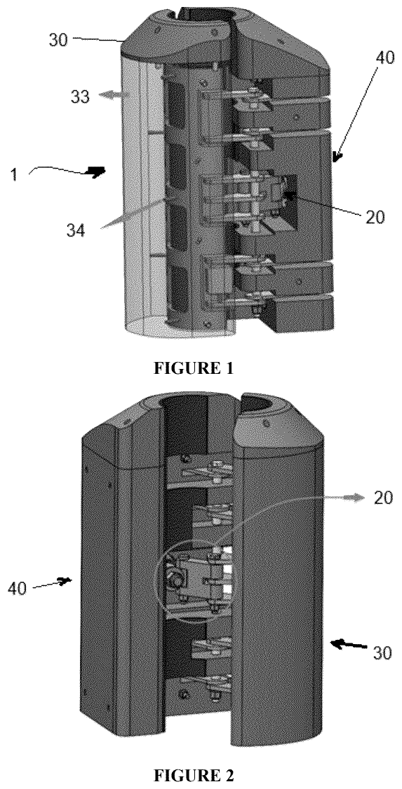

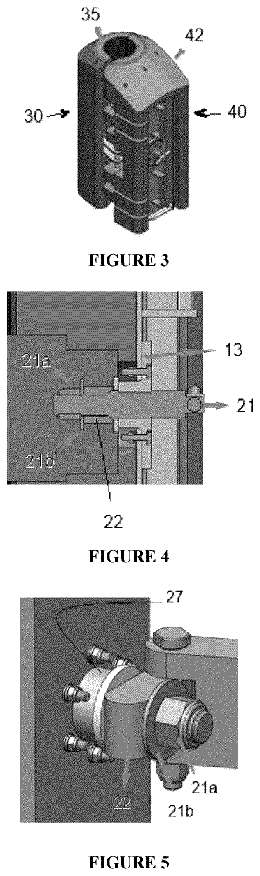

In a first embodiment, referring generally to FIG. 1 and FIG. 7, remotely operated vehicle (ROV) operable pipe protection sleeve 1, that does not need additional tools for installation, comprises remotely operated vehicle ROV interface panel 10 and clamp actuator 20 and is a fully ROV operable tool that does not need additional tools for installation, which makes it possible to install ROV operable protection sleeve 1 on a pipeline, riser, umbilical, or other structure subsea (referred to simply herein as the “pipe”) already in operation after the pipe deployment. As described more fully below, ROV operable pipe protection sleeve 1 may be used to embrace the pipe in a region where it is desired to protect against contact arising from interference between subsea pipes or structures. Riser protection sleeve 1 has a friendly interface for ROV handling and does not require an additional tool for installation. Typically, ROV 200 (FIG. 12) with its manipulators is sufficient for operation and installation of operable pipe protection sleeve 1. Riser protection sleeve 1 may be designed according to each pipe's external diameter, with a customized project for each need.

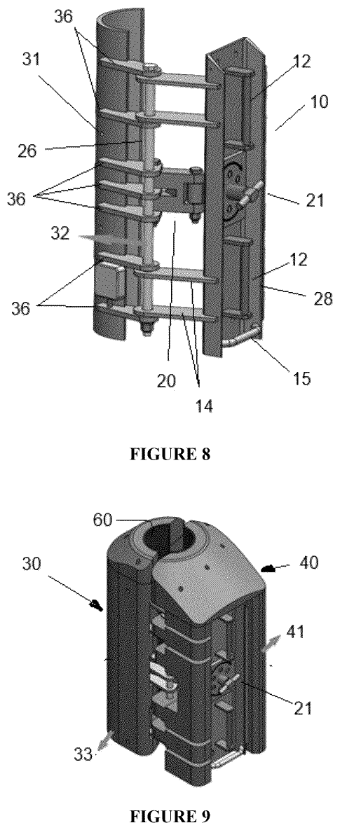

ROV interface panel 10 accommodates spindle 21 and acts as a docking and handling point for ROV 200 (FIG. 12). ROV interface panel 10 also contains one or more anodes 15 (FIG. 8), which are part of the system's cathodic protection. Spindle 21 typically comprises Inconel 718.

ROV interface panel 10 comprises ROV interface panel anode 15 (FIG. 8), a predetermined set of panel padeyes 14 (FIG. 8), and a predetermined set of ROV handles 12. Interface panel 10 typically further comprises a predetermined set of interface panel fasteners 11 configured to secure interface panel 10 to fixed clamp 40 (FIG. 1) and a predetermined set of flange fasteners 21c configured to secure spindle 21 to interface panel 10.

In embodiments, referring additionally to FIG. 8, ROV interface panel 10 comprises C-channel 28 which opens to an exterior portion of fixed clamp 40 and is typically an 8-inch channel laminated from carbon steel ASTM A36. In embodiments, the predetermined set of panel padeyes 14 are welded to C-channel 28 using partial penetration with a reinforcing fillet and comprise carbon steel. In embodiments, ROV handles 12 comprise carbon steel SAE 1020 and/or ASTM A36 and are also welded to C-channel 28, typically by full penetration welding.

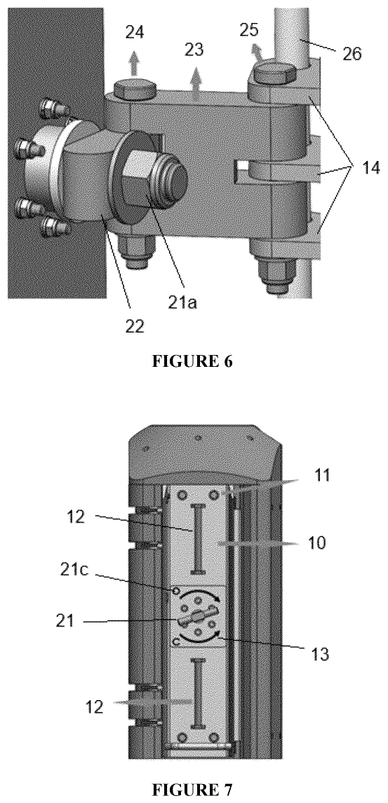

Clamp actuator 20 comprises spindle 21 disposed proximate a central part of the ROV interface panel 10 where spindle 21 is exposed to an outer portion of ROV interface panel, 10, arm 23 (FIG. 6) comprising an interior port, pushing plate 22 (FIG. 6) comprising an interior port where pushing plate 22 is configured to accept spindle 21 through the interior port and where pushing plate 22 is hingedly connected to arm 23, and bipartite clamp 30,40 (FIG. 1) which is adapted to embrace a pipe in a region where it is desired to protect the pipe against contact arising from interference between subsea structures such as other pipes. Pushing plate 22 typically comprises 17-4PH stainless steel and an inner void configured to accept spindle 21 therethrough, and spindle 21 fixed by nut 21a at an end that passes through inner void. Arm 23 typically comprises 17-4PH stainless steel.

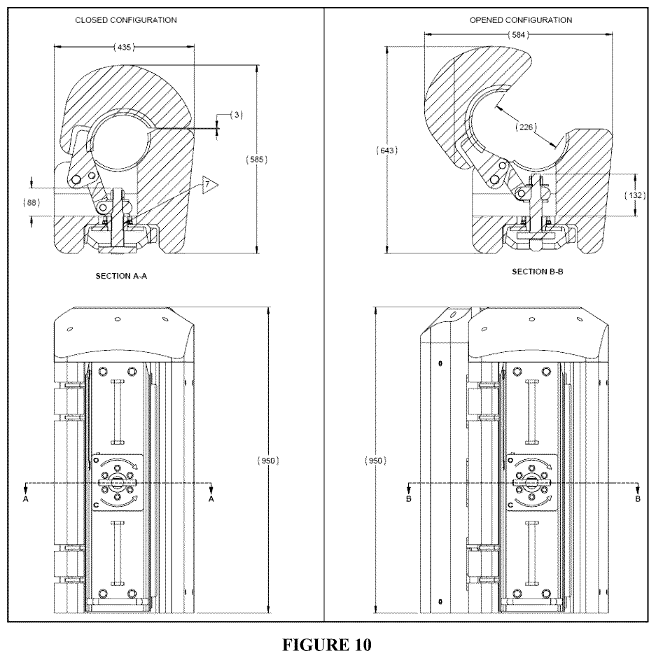

Referring now to FIG. 9, bipartite clamp 30,40 comprises fixed clamp 40 and movable clamp 30. Fixed clamp 40 is hingedly connected to clamp actuator 20 (FIG. 1) and fixed to ROV interface panel 10 (FIG. 7) and typically comprises fixed clamp float 41

Movable clamp 30 comprises movable clamp float 33 and cage 31 (FIG. 8). Cage 31 is hingedly connected to fixed clamp 40 via clamp actuator 20 and is typically semi-tubular. Cage 31 comprises a predetermined set of cage padeyes 36 which are typically carbon steel padeyes welded using conventional welding processes in which a partial penetration weld and reinforcement fillet are made. Cage 31 typically comprises VMec 134AP and padeyes 36, which are typically welded to cage 31, typically comprise ASTM A572 Gr.50, all of which are made of carbon steel.

Clamp actuator 20 typically further comprises one or more spindle washers 21b (FIG. 5) and spindle fixing nut 21a (FIG. 5) configured to secure spindle 21 (FIG. 7) to pushing plate 22. In embodiments, clamp actuator 20 further comprises a predetermined set of pins 24,25 (FIG. 6), where pushing plate 22 is hingedly connected to arm 23 via a first pin 24 of the predetermined set of pins 24,25 and arm 23 hingedly connected to ROV interface panel 10 by a second pin 25 of the predetermined set of pins 24,25, second pin 25 typically passing through a set of concentric holes the predetermined set of padeyes 14. In embodiments, cage 31 is hingedly connected to ROV interface panel 10 through third pin 26 which is disposed through the predetermined set of cage padeyes 36 (FIG. 8) and the predetermined set of panel padeyes 14, thereby hingedly linking fixed clamp 40 and movable clamp 30.

In embodiments, movable clamp float 33 comprises a polymer and cage 31 is operatively connected to movable clamp float 33 by fasteners such as flat-head screws that pass through concentric holes in the pipe and movable clamp float 33.

Similarly, fixed clamp float 41 (FIG. 9) typically comprises a polymer and ROV interface panel 10 is fixed to fixed clamp float 41 by fasteners such as by four half-inch screws.

ROV interface panel 10 may further comprise flange 13 (FIG. 7) disposed proximate a central portion of the ROV instrument panel 10 where flange 13 comprises central nut 27 (FIG. 5) adapted to accept spindle 21 therethrough. Flange 13 may comprise carbon steel and use fasteners, e.g., fixing screws, which comprise class 8.8 carbon steel. Flange 13 may be designed by full penetration welding of two separate pieces, one being the center nut made of SAE 1020 and the square profile plate of ASTM A572 Gr.50. In embodiments, ROV interface panel 10 further comprises two or more ROV handles 12 (FIG. 7) which are aligned along a longer axis of ROV interface panel 10 and disposed on either side of flange 13.

In embodiments, spindle 21 comprises a T-bar shaped screw and is connected to ROV interface panel 10 through flange 13, where spindle 21 and flange 13 act as a screw and nut. Spindle 21 may be manufactured from the joining of two round bars to form the T-bar with a fillet weld along the entire contour of the joint between the two pieces.

An inner diameter of ROV operable pipe protection sleeve 1 is typically designed so that an entire diametrical range of the pipe to be protected will be met with the same tightening efficiency, given a set of manufacturing dimensional tolerances. Further, ROV operable pipe protection sleeve 1 may comprise a layer of rubber 60 (FIG. 9) on faces of an internal diameter of ROV operable pipe protection sleeve 1 where there will be contact with the pipe, this layer of rubber adapted to protect and adapt to imperfections of an external sheath of the pipe.

Typically, ROV operable pipe protection sleeve 1 comprises a predetermined set of metallic and polymeric components, the metallic parts typically comprising carbon steel and stainless-steel parts. In most embodiments, the entire system is protected by cathodic protection along with specific painting procedures for each type of material, ensuring a useful life compatible with the riser to which ROV operable pipe protection sleeve 1 will be attached.

The polymeric part typically consists of the entire outside of ROV operable pipe protection sleeve 1, designed so that adjacent pipes do not come into contact with any metallic part in order to preserve an outer sheath of the pipe that is in contact with the outside of ROV operable protection sleeve 1. The polymeric components typically comprise fixed clamp float 41 (FIG. 9) and movable clamp float 33 (FIG. 9), each comprising a syntactic foam covered by a layer of polypropylene around their entire contour, typically a 12 mm layer of polypropylene, and a plurality of solid polypropylene pieces fixed to an upper end of fixed clamp float 41 and movable clamp float 33. The solid polypropylene pieces typically serve as wedges 35,42 (FIG. 1), in order to protect the ROV operable pipe protection sleeve 1 against shocks in an axial direction of a protected riser. In addition, fixed clamp float 41 and movable clamp float 33 act as buoyancy modules and provide a buoyancy for ROV operable pipe protection sleeve 1 to reach a low submerged weight around negative 5 kg. The characteristic of this low submerged weight aids in installation flexibility in lines with lazy wave configuration, as with this added low weight the chances of modification to the original lazy wave configuration may be minimized.

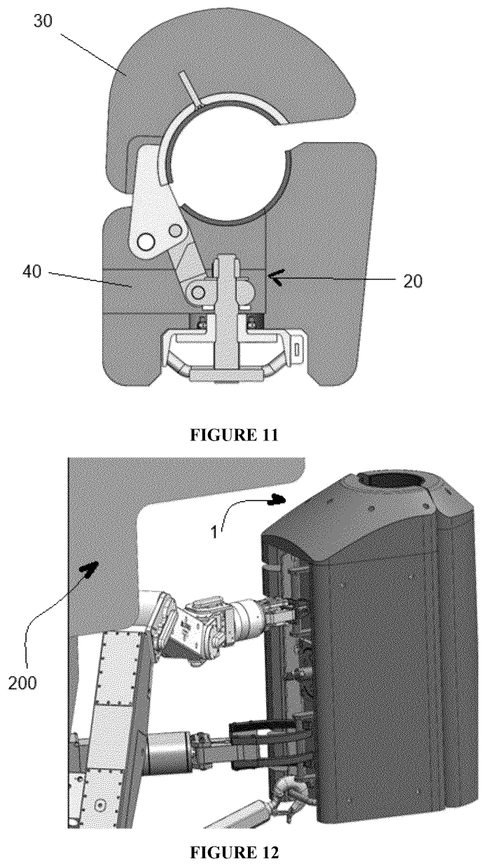

In the operation of exemplary methods, referring back to FIG. 1 and additionally to FIGS. 10-12, as will be understood by one of ordinary skill, ROV operable protection sleeve 1 comprises and defines a clamp fully operated by ROV 200 (FIG. 12) without the need for any auxiliary equipment for its operation/installation, and all actuation and operation of ROV operable protection sleeve 1 is mechanical without the need to use hydraulics from ROV 200, as is commonly the case in ROV operated tools. With this configuration, ROV operable protection sleeve 1 gains operational versatility due to its simplicity of operation.

ROV riser protection sleeve 1, described above, may protect a pipe without the need for any auxiliary equipment for its operation/installation. All actuation and operation of ROV operable protection sleeve 1 is mechanical and does not need to use hydraulics from ROV 200 (FIG. 12). Assembly may occur subsea and ROV operable pipe protection sleeve 1 may be positioned about a pipe subsea with movable clamp 30 being displaced from fixed clamp 40, e.g., in an open position. The pipe is accepted into an interior of the ROV operable pipe protection sleeve 1 and ROV operable pipe protection sleeve 1 activated by rotating spindle 21, e.g., by ROV 200, to close moveable clamp 30 with respect to fixed clamp 40. This is accomplished by allowing flange 13 to operate together with spindle 21 by acting as a nut of spindle 21 and flange 13. Typically, after movable clamp 30 is completely opened and ROV operable protection sleeve 1 fitted to the pipe, ROV 200 need only rotate spindle 21 in a first direction for closing and apply the specified torque to ensure tightness and grip between ROV operable protection sleeve 1 and the pipe.

ROV 200 (FIG. 12) may be used to rotate spindle 21 after movable clamp 30 is opened and ROV operable pipe protection sleeve 1 is fitted to or about the pipe to close movable clamp 30 with respect to fixed clamp 40 and apply a specified torque to ensure tightness and grip between ROV operable pipe protection sleeve 1 and the pipe. In embodiments, an ROV operator has the option of choosing which of the two ROV handles to use for the rotation operation.

In embodiments, flange 13 also indicates a spindle rotation direction for an opening or a closing action which may, in turn, be useful to an ROV operator.

ROV operable protection sleeve 1 can operate at depths of up to 2000 m, as the buoyancy modules 33,41 can handle operating at this depth without losing buoyancy effectiveness. In addition, ROV operable protection sleeve 1 can protect a pipe against shocks from other pipes in a region where ROV operable protection sleeve 1 is installed, increasing the useful life and safety of the protected pipe. ROV operable protection sleeve 1 may be designed according to impact requests between the lines.

The foregoing disclosure and description of the inventions are illustrative and explanatory. Various changes in the size, shape, and materials, as well as in the details of the illustrative construction and/or an illustrative method may be made without departing from the spirit of the invention.

1. A remotely operated vehicle (ROV) operable pipe protection sleeve that does not need additional tools for installation, comprising:
a. a remotely operated vehicle (ROV) interface panel, comprising:
i. an ROV interface panel anode;
ii. a predetermined set of panel padeyes; and
iii. a predetermined set of ROV handles;
b. a clamp actuator fixed to the ROV interface panel, comprising
i. a spindle disposed proximate a central part of the ROV interface panel;
ii. an arm comprising an interior port; and
iii. a pushing plate comprising an interior port, the pushing plate configured to accept the spindle through the interior port, the pushing plate hingedly connected to the arm; and
c. a bipartite clamp adapted to embrace a pipe in a region where it is desired to protect the pipe against contact arising from interference between subsea lines, comprising:
i. a fixed clamp hingedly connected to the clamp actuator, the fixed clamp comprising a fixed clamp float; and
ii. a movable clamp, comprising:
1. movable clamp float; and
2. a cage comprising a predetermined set of cage padeyes, the cage hingedly connected to the fixed clamp via the clamp actuator and the predetermined set of cage padeyes.

2. The remotely operated vehicle (ROV) operable pipe protection sleeve that does not need additional tools for installation of claim 1, wherein:
a. the ROV interface panel further comprises a predetermined set of interface panel fasteners configured to secure the interface panel to the fixed clamp;
b. the interface panel is secured to the fixed clamp using the predetermined set of interface panel fasteners;
c. the clamp actuator further comprises:
i. a spindle washer and spindle fixing nut securing the spindle to the pushing plate;
ii. a predetermined set of pins, the pushing plate hingedly connected to the arm via a first pin of the predetermined set of pins, the arm hingedly connected to the instrument panel by a second pin of the predetermined set of pins passing through a set of concentric holes the predetermined set of panel padeyes and through the arm; and
d. the cage is hingedly connected to the ROV interface panel using a third pin disposed through the predetermined set of cage padeyes and the predetermined set of panel padeyes.

3. The fully remotely operated vehicle (ROV) operable pipe protection sleeve that does not need additional tools for installation of claim 1, wherein:
a. the ROV interface panel comprises a C-channel laminated from carbon steel (ASTM A36); and
b. the predetermined set of panel padeyes are welded to the C-channel and comprise carbon steel.

4. The fully remotely operated vehicle (ROV) operable pipe protection sleeve that does not need additional tools for installation of claim 3, wherein:
a. the C-channel is laminated from carbon steel (ASTM A36); and
b. the predetermined set of panel padeyes comprise carbon steel.

5. The fully remotely operated vehicle (ROV) operable pipe protection sleeve that does not need additional tools for installation of claim 1, wherein:
a. the movable clamp float comprises a polymer;
b. the cage is operatively connected to the movable clamp float by a predetermined set of fasteners that pass through concentric holes in the pipe and the movable clamp float;
c. the fixed clamp float comprises a polymer; and
d. the ROV interface panel is fixed to the fixed clamp float by a predetermined set of fasteners.

6. The fully remotely operated vehicle (ROV) operable pipe protection sleeve that does not need additional tools for installation of claim 1, wherein the ROV interface panel further comprises two ROV handles aligned along a longer axis of the ROV interface panel on opposite sides of the spindle.

7. The fully remotely operated vehicle (ROV) operable pipe protection sleeve that does not need additional tools for installation of claim 1, wherein the ROV interface panel further comprises:
a. a flange disposed proximate a central portion of the instrument panel, the flange comprising a central nut adapted to accept the spindle therethrough; and
b. a predetermined set of flange fasteners that secure the flange to the interface panel.

8. The fully remotely operated vehicle (ROV) operable pipe protection sleeve that does not need additional tools for installation of claim 7, wherein the spindle comprises a T-bar shaped screw and is connected to the ROV interface panel through the flange, the spindle and flange acting as a screw and nut.

9. The fully remotely operated vehicle (ROV) operable pipe protection sleeve that does not need additional tools for installation of claim 1, wherein the pushing plate comprises an inner void configured to accept the spindle therethrough, the spindle fixed by a nut at an end that passes through the inner void.

10. The fully remotely operated vehicle (ROV) operable pipe protection sleeve that does not need additional tools for installation of claim 1, wherein an inner diameter of the ROV operable pipe protection sleeve is designed so that an entire diametrical range of a pipe to be protected will be met with an equivalent tightening efficiency for a predetermined set of manufacturing dimensional tolerances.

11. The fully remotely operated vehicle (ROV) operable pipe protection sleeve that does not need additional tools for installation of claim 1, further comprising a layer of rubber on faces of an internal diameter of the ROV operable pipe protection sleeve where there will be contact with a pipe, the layer of rubber adapted to protect and adapt to imperfections of an external sheath of the pipe.

12. The fully remotely operated vehicle (ROV) operable pipe protection sleeve that does not need additional tools for installation of claim 1, wherein the ROV operable pipe protection sleeve comprises a predetermined set of metallic and polymeric components.

13. The fully remotely operated vehicle (ROV) operable pipe protection sleeve that does not need additional tools for installation of claim 12, wherein:
a. the metallic parts comprise carbon steel and stainless-steel parts; and
b. the entire system is protected by cathodic protection along with specific painting procedures for each type of material.

14. The fully remotely operated vehicle (ROV) operable pipe protection sleeve that does not need additional tools for installation of claim 12, wherein the polymeric parts comprise the fixed clamp float and the movable clamp float, each comprising:
a. a syntactic foam covered by a layer of polypropylene around their entire contour; and
b. a plurality of solid polypropylene pieces fixed to an upper end of each of the fixed clamp float and the movable clamp float, the solid polypropylene pieces serving as wedges in order to protect the ROV operable pipe protection sleeve against shocks in an axial direction of a protected riser.

15. The fully remotely operated vehicle (ROV) operable pipe protection sleeve that does not need additional tools for installation of claim 14, wherein the fixed clamp float and the movable clamp float provide a buoyancy for the ROV operable pipe protection sleeve to reach a low submerged weight of around negative 5 kg.

16. A method of providing riser protection using a remotely operated vehicle (ROV) operable pipe protection sleeve fully operatable by a remotely operated vehicle (ROV) without the need for any auxiliary equipment for its operation/installation and where all actuation and operation of the sleeve is mechanical without the need to use the ROV's hydraulics, the ROV operable pipe protection sleeve comprising a remotely operated vehicle (ROV) interface panel which comprises an ROV interface panel anode, a predetermined set of panel padeyes, and a predetermined set of ROV handles; a clamp actuator fixed to the ROV interface panel which comprises a spindle disposed proximate a central part of the ROV interface panel, an arm comprising an interior port; and a pushing plate comprising an interior port where the pushing plate is configured to accept the spindle through the interior port and where the pushing plate is hingedly connected to the arm; and a bipartite clamp adapted to embrace a pipe in a region where it is desired to protect the pipe against contact arising from interference between subsea lines which comprises a fixed clamp hingedly connected to the clamp actuator, the fixed clamp comprising a fixed clamp float, and a movable clamp which comprises movable clamp float and a cage comprising a predetermined set of cage padeyes where the cage is hingedly connected to the fixed clamp via the clamp actuator and the predetermined set of cage padeyes, the method comprising:
a. positioning the ROV operable pipe protection sleeve about a pipe subsea, the movable clamp displaced from the fixed clamp;
b. accepting the pipe into an interior of the ROV operable pipe protection sleeve; and
c. activating the ROV operable pipe protection sleeve by rotating the spindle to close the moveable clamp with respect to the fixed clamp by allowing the flange to operate together with the spindle by acting as a nut of the spindle and flange.

17. The method of claim 16, further comprising using an ROV to rotate the spindle after the movable clamp is opened and the ROV operable pipe protection sleeve is fitted to the pipe to close the movable clamp with respect to the fixed clamp and apply a predetermined torque to ensure tightness and grip between the ROV operable pipe protection sleeve and the riser.

18. The method of claim 17, wherein an ROV operator has the option of choosing which of the two ROV handles to use for the rotation operation.

19. The method of claim 17, wherein the flange of the ROV interface panel also indicates a spindle rotation direction for an opening or a closing action.
